(19) United States
(12) Patent Application Publication
(10) Pub. No.: US 2024/0219081 A1
(43) Pub. Date: Jul. 4, 2024

(54) STEAM SUPPLY SYSTEM AND STEAM SUPPLY METHOD FOR CAPTURING CARBON DIOXIDE SHIP ONBOARD USING ENGINE exhaust gas HEAT SOURCE AND HEAT PUMP UNDER 150°C

(71) Applicant: KOREA INSTITUTE OF OCEAN SCIENCE & TECHNOLOGY, Busan (KR)

(72) Inventors: Young-Kyun SEO, Busan (KR); Eun-Young PARK, Busan (KR); Seong-Jong HAN, Daejeon (KR); Meang-Ik CHO, Daejeon (KR); Ki-Young Sung, Gongju-si (KR)

(21) Appl. No.: 18/524,144

(22) Filed: Nov. 30, 2023

(30) Foreign Application Priority Data
Dec. 29, 2022 (KR) 10-2022-0188591

(51) Int. Cl. F25B 27/02; F25B 9/00; F25B 25/00; F25B 39/04

(52) U.S. Cl. CPC F25B 27/02; F25B 9/008; F25B 25/005; F25B 39/04

(57) ABSTRACT

An object of the present disclosure is to provide a steam supply system and a steam supply method for capturing carbon dioxide ship onboard under 150° C., which can economically secure an additionally required steam in addition to a steam production amount through an exhaust gas heat source at a high temperature of 150° C. or more by using engine exhaust gas discharged to the atmosphere, that is, an exhaust gas heat source due to a low temperature of approximately 70 to 150° ° C. in addition to a boiler.

In order to achieve the object, a steam supply system for capturing carbon dioxide ship onboard under 150° C. according to the present disclosure includes: an evaporator into which engine exhaust gas discharged from an engine is input; and an internal heat exchanger recovering heat of a refrigerant evaporated and discharged by the evaporator.

### CROSS-REFERENCE TO RELATED APPLICATIONS

This application claims the priority of Korean Patent Application No. 10-2022-0188591 filed on Dec. 29, 2022, in the Korean Intellectual Property Office, the disclosure of which is incorporated herein by reference.

### BACKGROUND OF THE INVENTION

### Field of the Invention

The present disclosure relates to a steam supply system and a steam supply method for capturing carbon dioxide ship onboard under 150° ° C., and more particularly, to a steam supply system and a steam supply method for capturing carbon dioxide ship onboard using an engine exhaust gas heat source and a heat pump under 150° C.

### Description of the Related Art

In relation to a steam supply system for capturing carbon dioxide ship onboard, while an IMO initial strategy and the resulting ship carbon dioxide reduction regulation are expected to be strengthened later, a ship onboard carbon dioxide capture system capturing carbon dioxide included in ship engine exhaust gas, and liquefying and storing the carbon dioxide is attracting attention.

Among various capturing schemes of the ship onboard carbon dioxide capturing system, a wet capturing scheme using an amine solvent is evaluated as technology which is technically highly feasible, and is attracting attention.

In the case of the wet capturing scheme, a carbon dioxide capturing agent, i.e., an amine solvent captures the carbon dioxide in contact with exhaust gas in an absorber, and a rich amine solvent including the captured carbon dioxide is transferred to a regeneration tower through a pump on a bottom of the absorber.

In order to separate the carbon dioxide from the amine solvent transferred to the regeneration tower, the amine solvent should be heated, and to this end, generally, a steam is supplied to a re-boiler heat exchanger to heat the amine solvent.

The amine solvent heated and from which the carbon dioxide is separated is changed to a state in which the concentration of the carbon dioxide is low, i.e., a lean amine solvent, and transferred to the absorber again, and regenerated to a state in which a large amount of carbon dioxide can be captured.

A ship onboard carbon dioxide capturing apparatus in the related art generally produce the steam by using a heat source of the exhaust gas, and when the steam supply is additionally required, supplies a fuel to the boiler through the boiler, and combusts the supplied fuel to generate additional heat, and then produce the steam.

In this case, since the heat source is acquired only form the combustion of the fuel, a large amount of additional fuel is used, and a result, a large quantity of fuel cost increases as an additional steam is produced.

Consequently, a capturing capacity capable of economically performing ship onboard carbon dioxide capturing is determined according to a capacity capable of producing the steam from the exhaust gas.

However, the related art has a problem in that a large amount of fuel is consumed by producing a steam additionally required for capturing the carbon dioxide by using a heat amount of the fuel combusted in the boiler in addition to a steam production amount through using the exhaust gas heat source.

Further, the related art has a problem in that when an exhaust gas temperature decreases to 150° C. or less, a pressure of a steam which may be generated is low even though exhaust gas sensible heat at 150° C. or less is used, it is difficult to use the related art for ship onboard carbon dioxide capturing.

For example, in the case of 4-bar steam, since the temperature is approximately 143ºC, there is a problem in that steam supply of 4 bar or more is actually difficult by an exhaust gas heat source of 150° C. or less.

### SUMMARY OF THE INVENTION

In order to solve the problem in the related art, an object of the present disclosure is to provide a steam supply system and a steam supply method for capturing carbon dioxide ship onboard under 150° C., which can economically secure an additionally required steam in addition to a steam production amount through an exhaust gas heat source at a high temperature of 150° C. or more by using engine exhaust gas discharged to the atmosphere, that is, an exhaust gas heat source due to a low temperature of approximately 70 to 150° C. in addition to a boiler.

Further, another object of the present disclosure is to provide a steam supply system and a steam supply method for capturing carbon dioxide ship onboard under 150° C., which produce a steam discharged from an engine at 4 bar or more, and then produces a steam through a heat pump by using sensible heat of engine exhaust gas which is changed to have a lower temperature of 150° C. or less.

In order to achieve the object, a steam supply system for capturing carbon dioxide ship onboard under 150° C. according to the present disclosure includes: an evaporator into which engine exhaust gas discharged from an engine is input; and an internal heat exchanger recovering heat of a refrigerant evaporated and discharged by the evaporator.

Further, in the steam supply system for capturing carbon dioxide ship onboard under 150° C. according to the present disclosure, the engine exhaust gas is a heat source that recovers heat of the refrigerant.

Further, in the steam supply system for capturing carbon dioxide ship onboard under 150° C. according to the present disclosure, the refrigerant is heated or evaporated by using the heat source which is the engine exhaust gas, and discharged from the evaporator.

Further, in the steam supply system for capturing carbon dioxide ship onboard under 150° C. according to the present disclosure, the evaporator evaporates the refrigerant into gas having a humidity of 100%.

Further, the steam supply system for capturing carbon dioxide ship onboard under 150° C. according to the present disclosure includes a main compressor compressing the refrigerant of which heat is recovered by the internal heat exchanger.

Further, the steam supply system for capturing carbon dioxide ship onboard under 150° ° C. according to the present disclosure includes a condenser heat-exchanging the refrigerant compressed by the main compressor and water to generate a steam.

Further, the steam supply system for capturing carbon dioxide ship onboard under 150° C. according to the present disclosure includes a steam compressor recompressing the steam generated by the condenser.

Further, in order to achieve the object, a steam supply method for capturing carbon dioxide ship onboard under 150° ° C. according to the present disclosure includes: inputting, by an evaporator, engine exhaust gas discharged from an engine; and recovering, by an internal heat exchanger, heat of a refrigerant evaporated and discharged by the evaporator.

Further, in the steam supply method for capturing carbon dioxide ship onboard under 150° C. according to the present disclosure, the engine exhaust gas is a heat source that recovers heat of the refrigerant.

Further, in the steam supply method for capturing carbon dioxide ship onboard under 150° ° C. according to the present disclosure, the refrigerant is heated or evaporated by using the heat source which is the engine exhaust gas, and discharged from the evaporator.

Further, in the steam supply method for capturing carbon dioxide ship onboard under 150° C. according to the present disclosure, the evaporator evaporates the refrigerant into gas having a humidity of 100%.

Further, the steam supply method for capturing carbon dioxide ship onboard under 150° C. according to the present disclosure includes compressing, by a main compressor, the refrigerant of which heat is recovered by the internal heat exchanger.

Further, the steam supply method for capturing carbon dioxide ship onboard under 150° C. according to the present disclosure includes heat-exchanging, by a condenser, the refrigerant compressed by the main compressor and water to generate a steam.

Further, the steam supply method for capturing carbon dioxide ship onboard under 150° ° C. according to the present disclosure includes recompressing, by a steam compressor, the steam generated by the condenser.

Meanwhile, in order to achieve the object, a steam supply method for capturing carbon dioxide ship onboard under 150° ° C. according to the present disclosure includes: a heat pump generating a steam by using engine exhaust gas discharged from an engine as a heat source; and a steam recompression unit recompressing the steam generated by the heat pump.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the invention, and the present disclosure will be defined only by the scope of each claim of the claims.

According to the present disclosure, there is an effect in that it is possible to economically secure an additionally required steam in addition to a steam production amount through an exhaust gas heat source at a high temperature of 150° C. or more by using engine exhaust gas discharged to the atmosphere, that is, an exhaust gas heat source due to a low temperature of approximately 70 to 150° C. in addition to a boiler.

Further, according to the present disclosure, there is an effect in that a steam discharged from an engine at 4 bar or more is produced, and then a steam is produced through a heat pump by using sensible heat of engine exhaust gas which is changed to have a lower temperature of 150° C. or less.

### BRIEF DESCRIPTION OF THE DRAWINGS

FIG. 1 is a schematic view schematically illustrating a ship onboard carbon dioxide capturing system (wet amine capturing scheme) according to the related art.

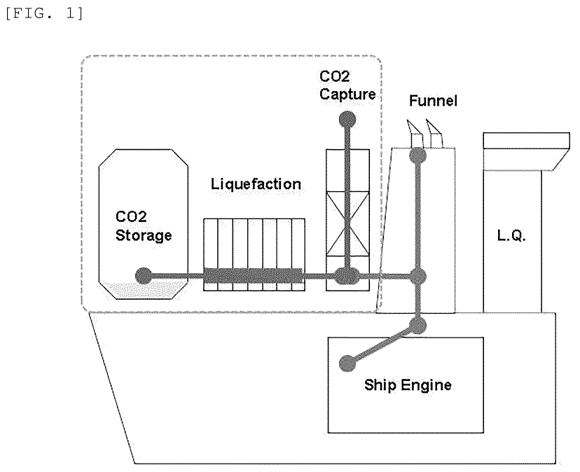

FIG. 2 is a block diagram of a feature configuration of the steam supply system for capturing carbon dioxide ship onboard under 150° C. according to an exemplary embodiment of the present disclosure.

FIG. 3 is a flowchart illustrating a feature flow of a steam supply method for capturing carbon dioxide ship onboard under 150° ° C. according to an exemplary embodiment of the present disclosure.

### DETAILED DESCRIPTION OF THE PREFERRED EMBODIMENT

Before describing the present disclosure in detail, the terms or words used in this specification should not be construed as being unconditionally limited to their ordinary or dictionary meanings, and in order for the inventor of the present disclosure to describe his/her invention in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but further includes any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side”, “other side”, “one side”, “other side”, “first”, “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number the indicates same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail with reference to related drawings.

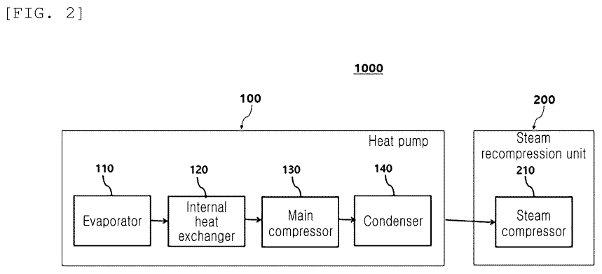

FIG. 2 is a block diagram of a feature configuration of the steam supply system for capturing carbon dioxide ship onboard under 150° C. according to an exemplary embodiment of the present disclosure.

Referring to FIG. 2, the steam supply system for capturing carbon dioxide ship onboard under 150° C. according to an exemplary embodiment of the present disclosure includes a main engine, a sub engine, a boiler, and a heat pump.

In the case of a ship engine recently applied to a ship, a turbo charger rear-end discharge temperature which is an exhaust gas temperature is approximately 190 to 220° C., and is lower than a temperature of exhaust gas of 350 to 450° C. in the past.

Therefore, a steam generation amount which may be supplied to the steam supply system for capturing carbon dioxide ship onboard, i.e., an exhaust gas sensible heat utilization based steam generation amount falls short of a capacity capable of capturing 90% of carbon dioxide included in the engine exhaust gas.

To this end, the present disclosure provides a configuration that may remarkably reduce fuel consumption upon generating a steam by using engine exhaust gas as a heat source.

The engine exhaust gas discharged at approximately 200° C. primarily produces a steam at 4 bar or more, and then has a lower temperature.

Exhaust gas at approximately 150° C. or less which belongs to a low temperature as the heat source that produces the steam at 4 bar (a saturation temperature of approximately 143ºC) or more, so the exhaust gas at 150° C. or less is not used as the heat source in association with the steam required for the ship onboard carbon dioxide capturing system.

In the exemplary embodiment, provided is an apparatus that may economically generate a steam at 3 to 5 bar by using sensible heat at an exhaust gas temperature interval at 70 to 150° C.

Exhaust gas at 70 to 150° C. is supplied to the low temperature-side evaporator 110 of the heat pump 100 to evaporate the refrigerant in the heat pump 100, and the evaporated refrigerant is compressed through the main compressor 130, and then the compressed high-temperature refrigerant is heat-exchanged with water to generate the steam.

When the steam is generated through the heat pump, if a temperature difference between a high temperature side and a low temperature side of the heat pump 100 is 60° C. or more, that is, when a low temperature-high temperature difference (temperature lift) of the heat pump is 60° C. or more, there is rapid performance reduction, so the steam is compressed through steam recompression to supply a steam at approximately 3 to 5 bar required in the wet amine capturing scheme of ship onboard carbon dioxide capturing system.

Therefore, according to the exemplary embodiment, the steam is economically generated to economically achieve a carbon dioxide capturing rate of the ship onboard carbon dioxide capturing system up to 90% of a ship engine discharge standard.

More specifically, the steam supply system 1000 for capturing carbon dioxide ship onboard under 150° C. according to the exemplary embodiment includes a high-temperature heat pump 100 and a steam recompression unit 200.

The heat pump 100 generates the steam by using the engine exhaust gas discharged from the engine as a heat source.

The heat pump 100 provides an additionally required steam in addition to a steam production amount through an exhaust gas heat source by using the engine exhaust gas discharged from the engine at a temperature of approximately 70 to 150° C. in addition to the boiler.

The refrigerant of the heat pump 100 may include pentane, water, n-butane, iso-butane, etc.

Further, the steam recompression unit 200 recompresses the steam generated by the heat pump 100.

A pressure of the steam which may be economically generated through the heat pump 100 is between approximately 1.5 and 3 bar, and steam recompression for compressing the corresponding steam at a pressure of the steam used in the wet amine capturing scheme, i.e., a 3 to 5 bar interval is performed by the steam recompression unit 200.

The heat pump 100 will be described in more detail.

The high-temperature heat pump 100 includes an evaporator 110, an internal heat exchanger 200, a main compressor 130, and a condenser 140.

The engine exhaust gas discharged from the engine is input into the evaporator 110.

The engine exhaust gas may be the heat source.

Further, the refrigerant may be heated or evaporated by using the heat source which is the engine exhaust gas, and discharged from the evaporator 110.

The engine exhaust gas as the heat source is input into the evaporator 110 in the heat pump 100, and the refrigerant of the heat pump 100, which is heated or evaporated by using the heat source which is the engine exhaust gas is also input into the evaporator 110.

The evaporator 110 may evaporate the refrigerant as gas having a humidity of 100%.

Next, the internal heat exchanger 120 recovers heat of the refrigerant discharged from the evaporator 110.

Further, the steam supply system 1000 for capturing carbon dioxide ship onboard according to the present disclosure may include the main compressor that compresses the refrigerant of which heat is recovered by the internal heat exchanger 120.

Of course, the steam supply system 1000 method for capturing carbon dioxide ship onboard according to the exemplary embodiment may be applied to both a heat pump 100 including a parallel compressor or a heat pump 100 not including the parallel compressor.

That is, the steam supply system 1000 for capturing carbon dioxide ship onboard according to the exemplary embodiment may include a parallel compressor or not include the parallel compressor.

In the evaporator 110, the refrigerant is evaporated into the gas having the humidity of 100%, and the heat in the refrigerant is additionally recovered through the internal heat exchanger 120, and then input and compressed in the main compressor.

Further, the condenser 140 heat-exchanges the refrigerant compressed by the main compressor 130 and water to generate the steam.

In particular, when the steam supply system 1000 for capturing carbon dioxide ship onboard according to the exemplary embodiment includes the parallel compressor, the condenser 140 heat-exchanges the refrigerant compressed by the parallel compressor and water with the main compressor 130 to generate the steam.

When the parallel compressor is included, there is an effect that efficiency of generating the steam by the condenser 140 may be increased.

The refrigerant compressed by the main compressor 130 is discharged at a high temperature, and the high-temperature refrigerant and water are heat-exchanged in the condenser 140 to generate the steam.

However, the pressure of the steam which may be economically generated through the heat pump 100 is between approximately 1.5 and 3 bar, and steam recompression for compressing the corresponding steam at a pressure of the steam used in the wet amine capturing scheme, i.e., a 3 to 5 bar interval is performed by the steam recompression unit 200.

More specifically, steam recompression is performed by the steam compressor 210 of the steam recompression unit 200.

That is, the steam supply system 1000 for capturing carbon dioxide ship onboard according to the present disclosure further includes the steam compressor 210, and the steam compressor 210 recompresses the steam generated by the condenser 140.

In the high-temperature heat pump 100 and the steam recompression unit 200 according to the exemplary embodiment, main energy required is electric energy required for driving the heat pump 100, and the steam compressor 150 used upon the steam recompression.

Further, it is possible to remarkably reduce required fuel consumption by using the heat resource which is the engine exhaust gas.

By such a configuration, there is an effect in that it is possible to economically secure an additionally required steam in addition to the steam production amount through an exhaust gas heat source by using the engine exhaust gas discharged from an engine at a temperature of approximately 70 to 150° C. as the heat source in addition to the boiler.

Further, there is an effect in that a steam required for operating a ship onboard carbon dioxide capturing system can be economically produced as compared with the existing boiler.

Further, there is an effect in that it is possible to increase a capturing rate (captured carbon dioxide/carbon dioxide discharged from an engine) capable of economically capturing carbon dioxide included in the ship.

Further, there is an effect in that it is possible to contribute ship carbon discharge reduction.

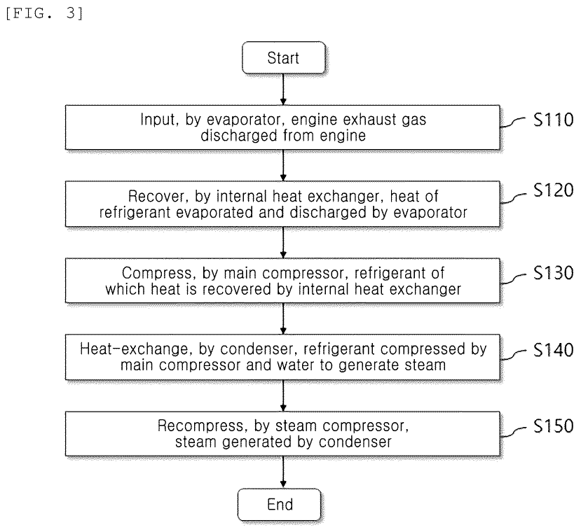

FIG. 3 is a flowchart illustrating a feature flow of a steam supply method for capturing carbon dioxide ship onboard under 150° ° C. according to an exemplary embodiment of the present disclosure.

Referring to FIG. 3, the steam supply system 1000 for capturing carbon dioxide ship onboard under 150° C. according to an exemplary embodiment of the present disclosure may be supplied by a steam supply method for capturing carbon dioxide ship onboard under 150° ° C. to be described below.

In the steam supply method for capturing carbon dioxide ship onboard under 150° C. according to the exemplary embodiment, the steam supply system 1000 for capturing carbon dioxide ship onboard under 150° ° C. includes the high-temperature heat pump 100 and the steam recompression unit 200.

The heat pump 100 generates the steam by using the engine exhaust gas discharged from the engine as a heat source.

The heat pump 100 provides an additionally required steam in addition to a steam production amount through an exhaust gas heat source by using the engine exhaust gas discharged from the engine at a temperature of approximately 70 to 150° ° C. in addition to the boiler.

The refrigerant of the heat pump 100 may include pentane, water, n-butane, iso-butane, etc.

Further, the steam recompression unit 200 recompresses the steam generated by the heat pump 100.

A pressure of the steam which may be economically generated through the heat is between pump 100 approximately 1.5 and 3 bar, and steam recompression for compressing the corresponding steam at a pressure of the steam used in the wet amine capturing scheme, i.e., a 3 to 5 bar interval is performed by the steam recompression unit 200.

Further, the steam supply method for capturing carbon dioxide ship onboard according to an exemplary embodiment of the present disclosure may include five steps.

In a first step S100, the engine exhaust gas discharged from the engine is input by the evaporator 110.

The high-temperature heat pump 100 includes an evaporator 110, an intermediate heat exchanger 200, a main compressor 130, and a condenser 140.

The engine exhaust gas discharged from the engine is input into the evaporator 110.

The engine exhaust gas may be the heat source.

Further, the refrigerant may be heated or evaporated by using the heat source which is the engine exhaust gas, and discharged from the evaporator 110.

The engine exhaust gas as the heat source is input into the evaporator 110 in the heat pump 100, and the refrigerant of the heat pump 100, which is heated or evaporated by using the heat source which is the engine exhaust gas is also input into the evaporator 110.

The evaporator 110 may evaporate the refrigerant as gas having a humidity of 100%.

In a second step S200, the heat of the refrigerant discharged from the evaporator 110 is recovered by the internal heat exchanger 120.

That is, the internal heat exchanger 120 recovers heat of the refrigerant discharged from the evaporator 110. In a third step S300, the refrigerant of which heat is recovered by the internal heat exchanger 120 is compressed by the main compressor.

Further, the steam supply method for capturing carbon dioxide ship onboard according to the present disclosure may include the main compressor 130 that compresses the refrigerant of which heat is recovered by the internal heat exchanger 120.

Of course, the steam supply method for capturing carbon dioxide ship onboard according to the exemplary embodiment may be applied to both the heat pump 100 including the parallel compressor 130 or the heat pump 100 not including the parallel compressor 130.

That is, the steam supply method for capturing carbon dioxide ship onboard according to the exemplary embodiment may include a parallel compressor or not include the parallel compressor.

In the evaporator 110, the refrigerant is evaporated into the gas having the humidity of 100%, and the heat in the refrigerant is additionally recovered through the internal heat exchanger 120, and then input and compressed in the main compressor.

In a fourth step S400, the condenser 140 heat-exchanges the refrigerant compressed by the main compressor 130 and water to generate the steam.

That is, the refrigerant compressed by the main compressor 130 is discharged at a high temperature, and the high-temperature refrigerant and water are heat-exchanged in the condenser 140 to generate the steam.

In particular, when the steam supply method for capturing carbon dioxide ship onboard according to the exemplary embodiment includes the parallel compressor, the condenser 140 heat-exchanges the refrigerant compressed by the parallel compressor and water with the main compressor 130 to generate the steam.

When the parallel compressor is included, there is an effect that efficiency of generating the steam by the condenser 140 may be increased.

In a fifth step S500, the steam generated by the condenser 140 is recompressed by the steam compressor 210.

The pressure of the steam which may be economically generated through the heat between pump 100 is approximately 1.5 and 3 bar, and steam recompression for compressing the corresponding steam at a pressure of the steam used in the wet amine capturing scheme, i.e., a 3 to 5 bar interval is performed by the steam recompression unit 200.

More specifically, steam recompression is performed by the steam compressor 210 of the steam recompression unit 200.

That is, the steam supply system 1000 for capturing carbon dioxide ship onboard according to the present disclosure further includes the steam compressor 210, and the steam compressor 210 recompresses the steam generated by the condenser 140.

In the high-temperature heat pump 100 and the steam recompression unit 200 according to the exemplary embodiment, main energy required is electric energy required for driving the heat pump 100, and the steam compressor 150 used upon the steam recompression.

Further, it is possible to remarkably reduce required fuel consumption by using the heat resource which is the engine exhaust gas.

As described above, according to the present disclosure, there is an effect in that it is possible to economically secure an additionally required steam in addition to a steam production amount through an exhaust gas heat source at a high temperature of 150° C. or more by using engine exhaust gas discharged to the atmosphere, that is, an exhaust gas heat source due to a low temperature of approximately 70 to 150° C. in addition to a boiler.

Further, according to the present disclosure, there is an effect in that a steam discharged from an engine at 4 bar or more is produced, and then a steam is produced through a heat pump by using sensible heat of engine exhaust gas which is changed to have a lower temperature of 150° C. or less.

Further, according to the present disclosure there is an effect in that a steam required for operating a ship onboard carbon dioxide capturing system can be economically produced as compared with the existing boiler.

Further, according to the present disclosure there is an effect in that it is possible to increase a capturing rate (captured carbon dioxide/carbon dioxide discharged from an engine) capable of economically capturing carbon dioxide included in a ship at 150° C.

Further, according to the present disclosure there is an effect in that it is possible to contribute ship carbon discharge reduction.

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

What is claimed is:

1. A steam supply system for capturing carbon dioxide ship onboard under 150° C., comprising:
an evaporator into which engine exhaust gas discharged from an engine is input; and
an internal heat exchanger recovering heat of a refrigerant evaporated and discharged by the evaporator.

2. The steam supply system for capturing carbon dioxide ship onboard under 150° ° C. of claim 1, wherein the engine exhaust gas is a heat source that recovers heat of the refrigerant.

3. The steam supply system for capturing carbon dioxide ship onboard under 150° ° C. of claim 2, wherein the refrigerant is heated or evaporated by using the heat source which is the engine exhaust gas, and discharged from the evaporator.

4. The steam supply system for capturing carbon dioxide ship onboard under 150° C. of claim 1, wherein the evaporator evaporates the refrigerant into gas having a humidity of 100%.

5. The steam supply system for capturing carbon dioxide ship onboard under 150° C. of claim 3, comprising:
a main compressor compressing the refrigerant of which heat is recovered by the internal heat exchanger.

6. The steam supply system for capturing carbon dioxide ship onboard under 150° ° C. of claim 5, comprising:
a condenser heat-exchanging the refrigerant compressed by the main compressor and water to generate a steam.

7. The steam supply system for capturing carbon dioxide ship onboard under 150° C. of claim 6, comprising:
a steam compressor recompressing the steam generated by the condenser.

8. A steam supply method for capturing carbon dioxide ship onboard under 150° C., comprising:
inputting, by an evaporator, engine exhaust gas discharged from an engine; and
recovering, by an internal heat exchanger, heat of a refrigerant evaporated and discharged by the evaporator.

9. The steam supply method for capturing carbon dioxide ship onboard under 150° ° C. of claim 8, wherein the engine exhaust gas is a heat source that recovers heat of the refrigerant.

10. The steam supply method for capturing carbon dioxide ship onboard under 150° ° C. of claim 9, wherein the refrigerant is heated or evaporated by using the heat source which is the engine exhaust gas, and discharged from the evaporator.

11. The steam supply method for capturing carbon dioxide ship onboard under 150° ° C. of claim 8, wherein the evaporator evaporates the refrigerant into gas having a humidity of 100%.

12. The steam supply method for capturing carbon dioxide ship onboard under 150° ° C. of claim 8, comprising:
compressing, by a main compressor, the refrigerant of which heat is recovered by the internal heat exchanger.

13. The steam supply method for capturing carbon dioxide ship onboard under 150° C. of claim 12, comprising:
heat-exchanging, by a condenser, the refrigerant compressed by the main compressor and water to generate a steam.

14. The steam supply method for capturing carbon dioxide ship onboard under 150° C. of claim 13, comprising:
recompressing, by a steam compressor, the steam generated by the condenser.

15. A steam supply system for capturing carbon dioxide ship onboard under 150° C., comprising:
a heat pump generating a steam by using engine exhaust gas discharged from an engine as a heat source; and
a steam recompression unit recompressing the steam generated by the heat pump.
